(19) United States
(12) Patent Application Publication
(10) Pub. No.: US 2014/0016893 A1
(43) Pub. Date: Jan. 16, 2014

(54) THRUST BEARING HOLDER AND THRUST BEARING

(71) Applicant: Makoto Nishikawa, Iwata-shi (JP)

(72) Inventor: Makoto Nishikawa, Iwata-shi (JP)

(21) Appl. No.: 14/006,816

(22) PCT Filed: Apr. 3, 2012
(86) PCT No.: PCT/JP2012/059109

§ 371 Date: Sep. 23, 2013

(30) Foreign Application Priority Data
Apr. 7, 2011 (JP) 2011-085261

(51) Int. Cl. F16C 33/46

(52) U.S. Cl. CPC F16C 33/467
USPC 384/623

(57) ABSTRACT

An object is to provide a retainer for a thrust bearing, from which rollers are not apt to drop once placed in pockets in the retainer in a manufacturing processes. A retainer is constituted by an annular member made from a flat steel plate; has a main body area in its widthwise intermediate region. The main body area has its outer circumferential edge formed with an outer circumferential engagement edge which is lower than a surface of the main body area. A large number of pockets are equi-spaced in a circumferential direction of the main body area in the thickness direction. Each of the pockets has a guide surface formed with anti-dropping projections of a roller for preventing the roller from dropping.

### TECHNICAL FIELD

The present invention relates to a retainer for a thrust bearing, and a thrust bearing which uses the retainer.

### BACKGROUND ART

Thrust bearings used in automobile transmissions or torque converters sometimes must be designed to have very short rollers due to very limited surface areas for the rollers to roll on a paired part.

Short rollers have a problem that their attitude is unstable in pockets in a retainer, and that rollers are more apt to drop from the pockets during manufacture (Patent Literature 1; see FIG. 2).

In order to prevent rollers from dropping, it is necessary to increase the depth of the pockets in the retainer, and to capture each of the rollers on its outer diameter surface at two locations which are radially as apart as possible from the center of the roller. Such a retainer has already known: It includes two retainer members each formed with grooves in an annular pattern; the two members are axially assembled with each other with the grooves opposed to each other to provide hollow spaces in an annular pattern; pockets which axially penetrates the space for holding the rollers are provided (Patent Literature 2).

However, this retainer requires some arrangement in order to prevent the two retainer members from being separated from each other. For example, it is necessary to provide knurling on the annular groove areas to make rough surfaces.

There are also known other retainers for thrust bearings: One example includes an annular metal plate each having its widthwise intermediate region formed with stepped bents arranged circumferentially all around the plate; and another example is to form generally S-shaped bents (Patent Literature 3). A problem in this type of retainers is a relatively thin plate thickness, which results in shallow pockets and therefore a narrow radial distance between anti-drop nails. In other words, short rollers (those having a short length) are apt to drop.

Still another example is a so-called trinity type thrust bearing in which an outer ring, an inner ring and a retainer between these are non-separable. In this type of thrust bearing, the outer ring has bent nails, or engagement margins are formed by means of staking. In this arrangement, resin retainers are subject to grinding wear, so resin retainers cannot be used in the trinity type.

### CITATION LIST

### Patent Literature

Patent Literature 1: Japanese Patent No. 3661133 Gazette

Patent Literature 2: Japanese Patent No. 3900843 Gazette

Patent Literature 3: JP-A H11-336751 Gazette

### SUMMARY OF INVENTION

### Technical Problem

In consideration to the conventional techniques as described above, it is an object of the present invention to provide a retainer from which rollers are not apt to drop once placed in pockets in the retainer in manufacturing processes; and to provide a thrust bearing using the retainer.

### Solution to Problem

In order to solve the above-mentioned problems, the present invention provides a retainer for a thrust bearing, which includes an annular member formed with a large number of pockets at an interval in a circumferential direction for holding rollers, wherein the annular member is made of a flat steel plate; has a main body area of a constant thickness in its widthwise intermediate region; the main body area has its outer circumferential edge formed with an outer circumferential engagement edge having a surface lower than that of the main body area; the pockets are equi-spaced in a circumferential direction of the main body area and are provided by through-holes in a thickness direction; and each pocket has its guide surfaces formed with anti-dropping projections for preventing a roller from dropping.

In cases where an outer ring is used in combination with the retainer which holds rollers, the outer ring has engaging hooks for engagement with the outer circumferential engagement edge to non-separatingly assemble the two components with each other.

In cases where an inner ring is added to the example described above, the retainer has an inner circumferential edge on a surface away from a surface formed with the outer circumferential engagement edge, and the inner circumferential edge is formed with an inner circumferential engagement edge which recedes from said surface. The inner ring is formed with engaging hooks for engagement with the inner circumferential engagement edge to non-separatingly assemble the three components together.

The retainer's main body area is has a thickness which is 0.5 through 0.9 times of a diameter of the rollers. This makes the pockets, which penetrate the main body area, deep enough to cover the rollers, thereby stabilizing the rollers' attitude and make them less apt to drop from the pockets.

Further, the anti-dropping projections for preventing the roller from dropping, at both axial end areas in both of the guide surfaces in a circumferential direction of the retainer of the pockets, ensure more reliable prevention of the rollers from dropping.

### Advantageous Effects of Invention

As described, the retainer according to the present invention is made of a flat annular steel plate; has pockets in a main body area of a constant thickness in its widthwise intermediate region. The arrangement ensures to provide a sufficient depth in the pocket, and therefore, even if the rollers are short, the rollers keep stable attitudes. Also, anti-dropping projections formed in each pocket, at both axial end areas in guide surfaces across the retainer's circumferential direction, reliably prevent the rollers from dropping out of the retainer in manufacturing processes.

Also, the retainer has an outer circumferential engagement edge or an inner circumferential engagement edge for engagement with the outer ring or with the inner ring. This provides a non-separating assembly of the two or the three components.

### BRIEF DESCRIPTION OF DRAWINGS

FIG. 1 is a plan view of a thrust bearing according to Embodiment 1.

FIG. 2 is a sectional view taken in lines X1-X1 in FIG. 1.

FIG. 3 is an enlarged sectional view of a portion taken from FIG. 1.

FIG. 4 is a perspective view of the retainer, showing its sections.

FIG. 5 is an enlarged sectional view taken in lines X2-X2 in FIG. 4.

FIG. 6 is a perspective view of another retainer, showing its sections.

FIG. 7 is an enlarged sectional view taken in lines X3-X3 in FIG. 6.

FIG. 8 is a perspective view of another retainer, showing its sections.

FIG. 9 is an enlarged sectional view taken in lines X4-X4 in FIG. 8.

FIG. 10 is a perspective view of another retainer, showing its sections.

FIG. 11 is an enlarged sectional view taken in lines X5-X5 in FIG. 10.

FIG. 12 is a plan view of a thrust bearing according to Embodiment 2.

FIG. 13 is a partially unillustrated enlarged sectional view taken in lines X6-X6 in FIG. 12.

FIG. 14 is an enlarged partial plan view of a portion in FIG. 12.

FIG. 15 is a partially unillustrated sectional view of a thrust bearing according to Embodiment 3.

FIG. 16 is a partially unillustrated enlarged sectional view of a thrust bearing according to Embodiment 4.

### DESCRIPTION OF EMBODIMENTS

Hereinafter, embodiments of the present invention will be described based on the attached drawings.

### Embodiment 1

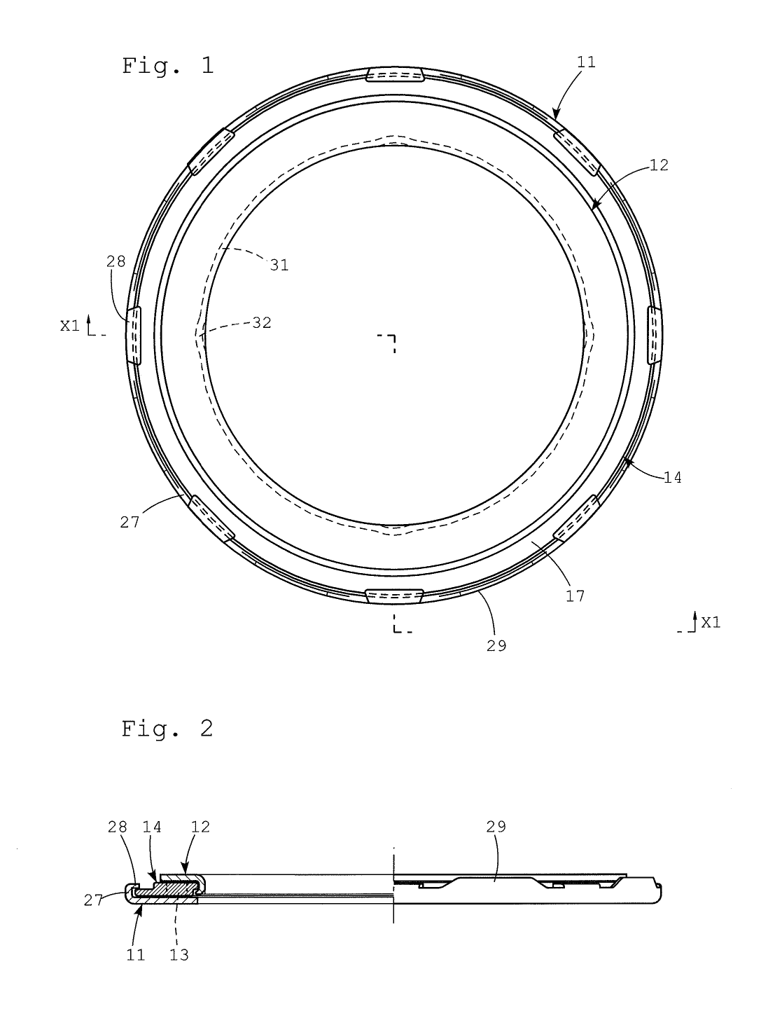

FIG. 1 through FIG. 5 show a thrust bearing according to Embodiment 1, which includes an outer ring 11, an inner ring 12, a predetermined number of rollers 13 between these two members, and a retainer 14 which holds the rollers 13.

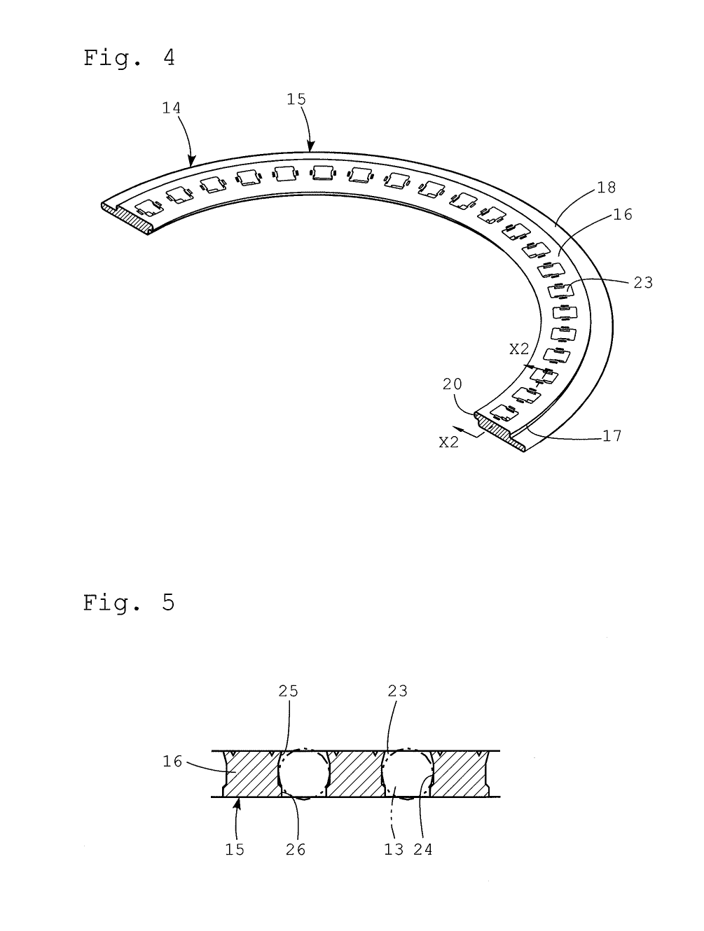

The retainer 14 is formed of a flat annular member 15 (see FIG. 4) which is made by punching a steel plate. The annular member 15 has a main body area 16 of a constant thickness, in its widthwise intermediate region. The main body area 16 has its outer circumferential edge region formed with a stepped area 17, which is surrounded by a thin, outer circumferential engagement edge 18. On a surface which is away from the one formed with the outer circumferential engagement edge 18, there is formed there is formed a thin, inner circumferential engagement edge 20 along its inner circumferential edge via a stepped area 19.

The outer circumferential engagement edge 18 and the inner circumferential engagement edge 20 can be formed by various kinds of machining processes such as pressing, coining, crushing, etc. In the embodiment shown in the figures, the outer circumferential engagement edge 18 has a greater width than the inner circumferential engagement edge 20.

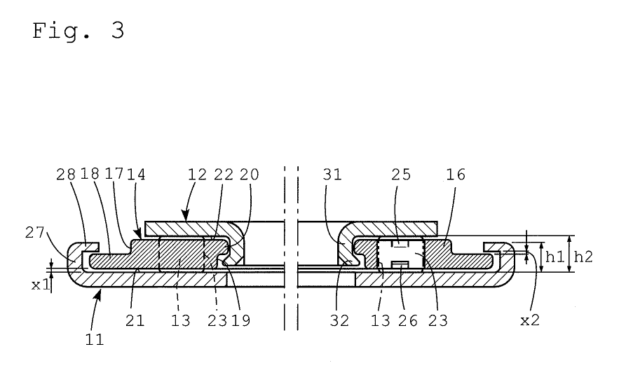

The main body area 16 described above has a thickness which is 0.5 through 0.9 times the diameter of the rollers 13. As shown in FIG. 3, slight gaps x1, x2 will develop during the use, between a track surface 21 of the outer ring 11 and the main body area 16, as well as between a track surface 22 of the inner ring 12 and the main body area 16, respectively. The main body area 16 has received no such machining processes as pressing, so the main body area 16 has a uniform thickness along its entire circumference and the steel material in this area has a uniform fiber flow.

As shown in FIG. 4 and FIG. 5, the main body area 16 is formed with a large number of rectangular pockets 23 at a constant interval along an entire circumference. Each pocket 23 is provided by a through-hole in a thickness direction of the main body area 16. The pocket 23 has two sides, each having a guide surface 24 and in both of them (i.e., in both guide surfaces 24 across the circumferential direction of the retainer 14), anti-dropping projections 25, 26 of the rollers 13 are formed at respective axial ends (see FIG. 5) in order to prevent the roller from dropping. These anti-dropping projections 25, 26 can be formed by swaging, stamping, burnishing, or other machining operations.

The outer ring 11 has an outer circumferential edge formed with an axially erected flange 27, which has an inner circumferential surface opposed to the outer circumferential engagement edge 18 of the retainer 14. The flange 27 is erected by a height which is slightly higher than a thickness of the outer circumferential engagement edge 18 in the retainer 14. The flange 27 has an engaging hook 28 at its tip edge, which is inwardly bent extending over the track surface 21, so that the bearing can have a large inner gap.

The engaging hook 28 is formed at a plurality of locations along the entire circumference, so each makes axial engagement with an outer circumferential engagement edge 18 of the retainer 14 with a certain engagement margin. As a result, the outer ring 11 and the retainer 14 are non-separatingly assembled with each other.

Between two mutually adjacent engaging hooks 28, the flange 27 has its upper end edge formed with a reinforcing piece 29 to extend upward but not to exceed the inner ring 12 (see FIG. 2), for reinforcement to the flange 27.

The inner ring 12 has an inner circumferential edge formed with an axially inward bending flange 31, which has an inner circumferential surface opposed to the inner circumferential engagement edge 20 of the retainer 14. The flange 31 has its tip edge formed with radially outward protruding engagement projections 32 at a plurality of locations along the circumferential direction. These engagement projections 32 make axial engagement with the inner circumferential engagement edge 20 of the retainer 14 with a predetermined engagement margin. As a result, the inner ring 12 and the retainer 14 are non-separatingly assembled with each other.

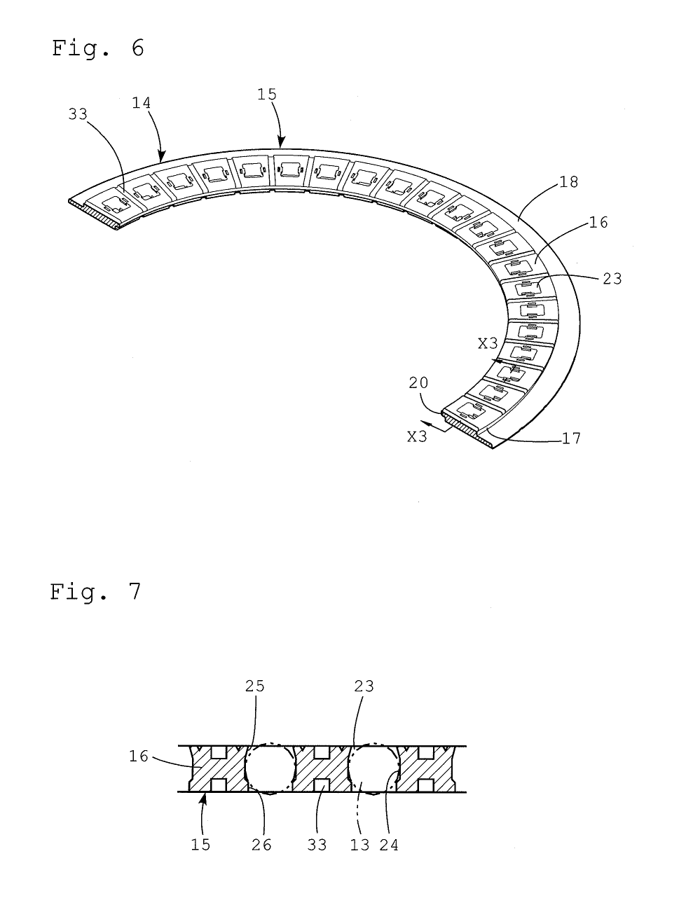

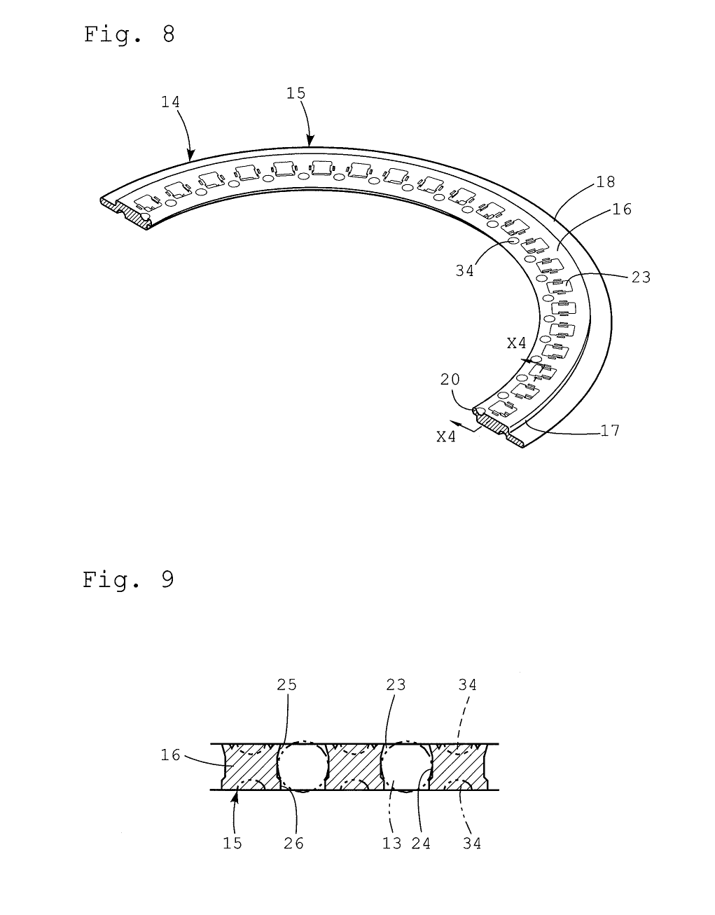

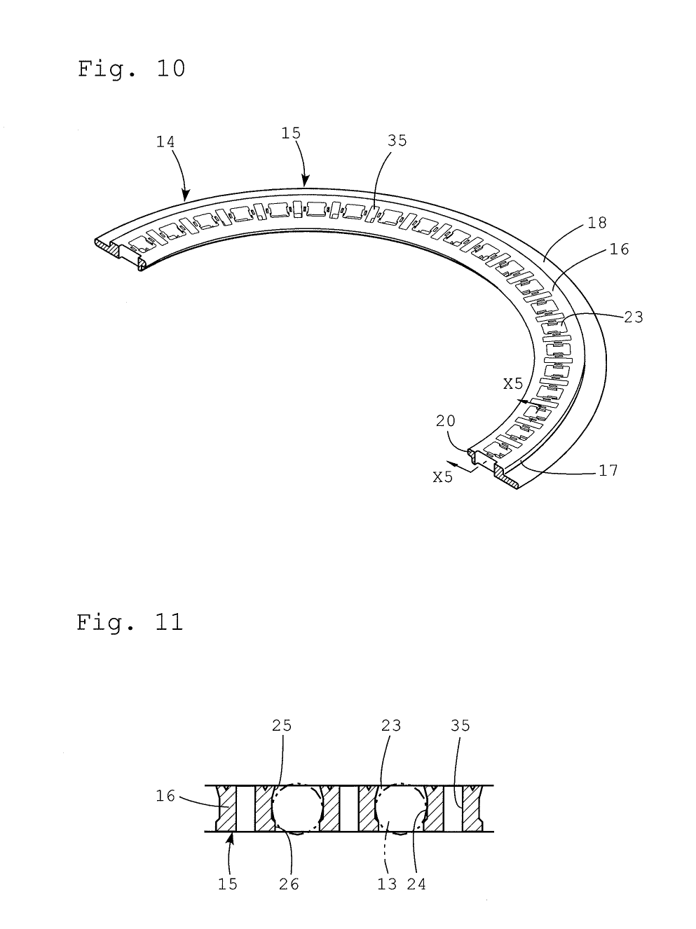

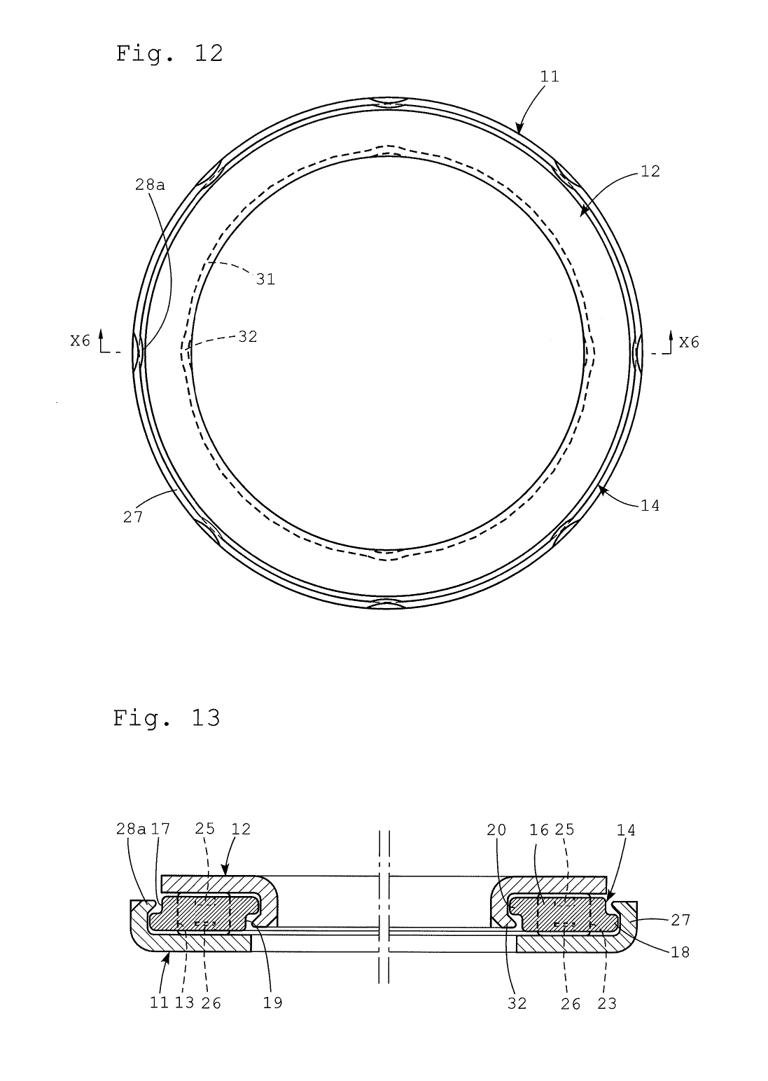

As a variation of the above-described retainer 14, FIG. 6 and FIG. 7 show a retainer which includes a main body area having both of its surfaces formed with grooves 33 alternating with the pockets 23. These grooves 33 decrease the weight of the retainer 14, while serving as places for lubricant to pool. FIG. 8 and FIG. 9 show another example of the same intent, where a main body area 16 is formed with recesses 34 along its inner circumferential edge, alternating with the pockets 23. FIG. 10 and FIG. 11 show still another example, where the pockets 23 are alternated with slit-like through-holes 35 for further weight reduction and improved flow of lubricant in the retainer 14.

The thrust bearing according to Embodiment 1 is as described thus far: The retainer 14 is made of a steel plate; has a main body area 16 of a constant thickness; and the main body area 16 is formed with pockets 23; so, most part of the rollers 13 are inside the pockets 23 except for very small portions (exposed to gaps x1, x2) which make contact with the track surfaces 21, 22 of the outer ring 11 and the inner ring 12. Therefore, even if the rollers are short, they keep stable attitudes.

Also, the anti-dropping projections 25, 26 provided on both guide surfaces 24 of the pockets 23 ensure reliable prevention of the rollers 13 from dropping.

### Embodiment 2

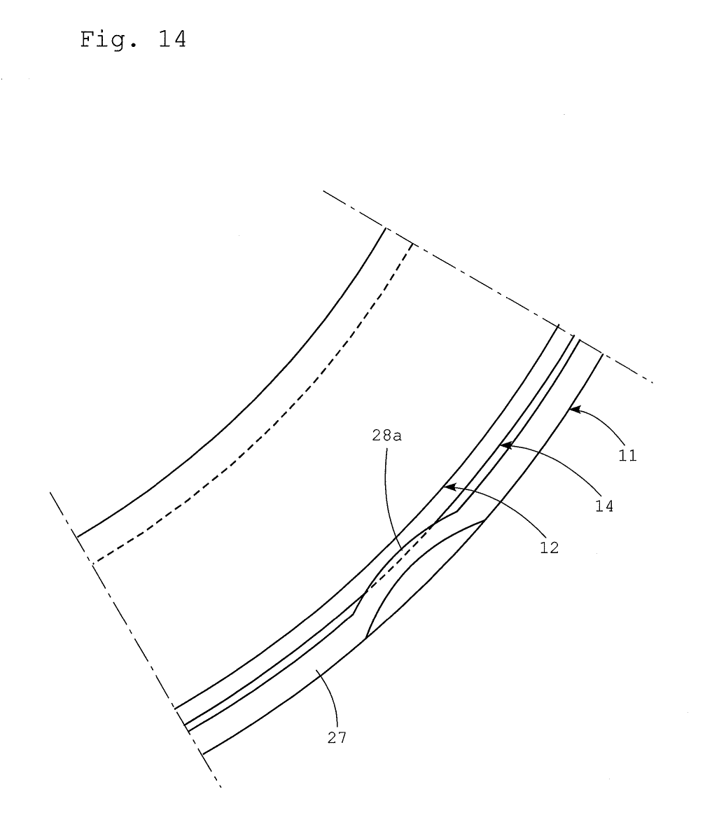

FIG. 12 through FIG. 14 show a thrust bearing according to Embodiment 2, which is basically identical with Embodiment 1, but as has been mentioned already, the outer circumferential engagement edge 18 in the retainer 14 according to Embodiment 2 has the same width as the width of the inner circumferential engagement edge 20, for applications where internal space in the bearing is relatively small. For this reason, engaging hooks 28a formed at the tip edge of the flange 27 in the outer ring 11 do not have to have a long protrusion, and therefore are formed by means of staking. Other arrangements are identical with those in Embodiment 1.

### Embodiment 3

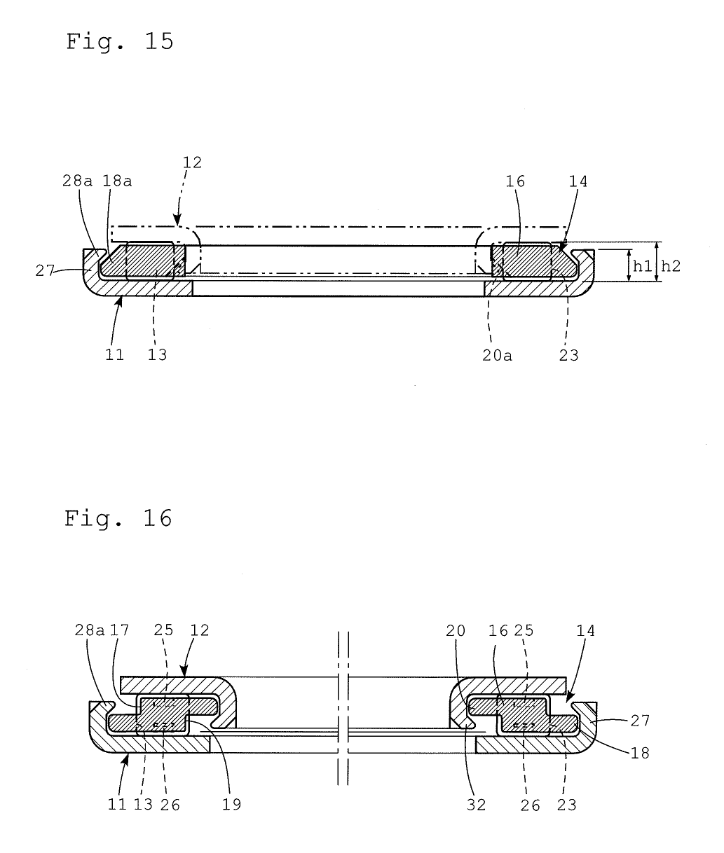

FIG. 15 shows a thrust bearing according to Embodiment 3, which is constituted by an outer ring 11, and a retainer 14 which holds rollers 13. This retainer 14 differs from those which have been described earlier, in that an outer circumferential engagement edge 18a formed on an outer circumferential edge in the main body area 16 is tapered. The outer ring 11 has a flange 27 which has its tip end edge formed with engaging hooks 28a by means of staking, and these engaging hooks 28a keep the outer ring 11 and the retainer 14 assembled with each other.

It should be noted here that if an inner ring 12 is used, a tapered inner circumferential engagement edge 20a is formed on a surface away from the surface where the outer circumferential engagement edge 18a, in the main body area 16 is formed.

### Embodiment 4

FIG. 16 shows a thrust bearing according to Embodiment 4, which basically follows the arrangements used in the previous Embodiment 1 and Embodiment 2, in that an annular member 15 has a main body area 16 of a constant thickness in its widthwise intermediate region, and this main body area 16 has its outer circumferential edge region formed with a stepped area 17, which is surrounded by a thin, outer circumferential engagement edge 18. Also, on a surface which is away from the one formed with the outer circumferential engagement edge 18, there is formed a thin, inner circumferential engagement edge 20 along its inner circumferential edge via a stepped area 19. The difference, however, from the previous Embodiment 1 and Embodiment 2 is that the stepped area 17 on the outer diameter side and the stepped area 19 on the inner diameter side are extended into the pockets 23.

The arrangement that the stepped area 17 on the outer diameter side and the stepped area 19 on the inner diameter side are extended into the pockets 23 improves lubricant flow and foreign matter discharge.

FIG. 16 shows a case where both the stepped area 17 on the outer diameter side and the stepped area 19 on the inner diameter side are provided beyond the pockets 23. However, at least one of the stepped area 17 on the outer diameter side and the stepped area 19 on the inner diameter side may be provided beyond the pockets 23.

### REFERENCE SIGNS LIST

11 outer ring
12 inner ring
13 rollers
14 retainer
15 annular member
16 main body area
17 stepped area
18, 18a outer circumferential engagement edge
19 stepped area
20, 20a inner circumferential engagement edge
21 track surface
22 track surface
23 pockets
24 guide surface
25 anti-dropping projection
26 anti-dropping projection
27 flange
28, 28a engaging hook
29 reinforcing piece
31 flange
32 engagement projection
33 groove
34 recess
35 through-hole

1. A retainer for a thrust bearing, comprising an annular member formed with a large number of pockets at a constant interval in a circumferential direction for holding rollers, wherein the annular member is made of a flat steel plate; has a main body area of a constant thickness in its widthwise intermediate region; the main body area has its outer circumferential edge formed with an outer circumferential engagement edge having a surface lower than that of the main body area; the pockets are equi-spaced in a circumferential direction of the main body area and are provided by through-holes in a thickness direction; and each pocket has its guide surface formed with anti-dropping projections for preventing a roller from dropping.

2. The retainer for a thrust bearing according to claim 1, wherein the outer circumferential engagement edge is lowered by a stepped area than a surface of the main body area.

3. The retainer for a thrust bearing according to claim 1, wherein the outer circumferential engagement edge is lowered by a tapered area than a surface of the main body area.

4. The retainer for a thrust bearing according to claim 1, wherein the main body area has an inner circumferential edge on a surface away from a surface formed with the outer circumferential engagement edge, and the inner circumferential edge is formed with an inner circumferential engagement edge which is lower than the main body area.

5. The retainer for a thrust bearing according to claim 4, wherein the inner circumferential engagement edge is lowered by a stepped area than a surface of the main body area.

6. The retainer for a thrust bearing according to claim 4, wherein the inner circumferential engagement edge is lowered by a tapered area than a surface of the main body area.

7. The retainer for a thrust bearing according to claim 1, wherein the main body area of the retainer has a thickness which is 0.5 through 0.9 times of a diameter of the rollers.

8. The retainer for a thrust bearing according to claim 1, wherein the anti-dropping projection for the roller is provided at each axial end section on both guide surfaces in the circumferential direction of the retainer in each of the pockets.

9. The retainer for a thrust bearing according to claim 1, wherein the main body area has grooves, recesses or holes alternating with the pockets.

10. A thrust bearing comprising the retainer for thrust bearing according to claim 1.

11. The thrust bearing according to claim 10, wherein the outer ring has an engaging hook for engagement with the outer circumferential engagement edge of the retainer.

12. The thrust bearing according to claim 10, wherein the inner ring has an engaging hook for engagement with the inner circumferential engagement edge of the retainer.
